(19) United States
(12) Patent Application Publication
(10) Pub. No.: US 2010/0287458 A1
(43) Pub. Date: Nov. 11, 2010

(54) METHOD, SYSTEM AND COMPUTER PROGRAM FOR FURNISHING INFORMATION TO CUSTOMER REPRESENTATIVES

(75) Inventors: Kieran Guller, Oakland, CA (US); Aashima Gupta, Union City, CA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: PROVIDIAN FINANCIAL CORPORATION, San Francisco, CA (US)

(21) Appl. No.: 11/468,329

(22) Filed: Aug. 30, 2006

Related U.S. Application Data
(62) Division of application No. 10/226,681, filed on Aug. 22, 2002, now abandoned.
(60) Provisional application No. 60/353,813, filed on Feb. 1, 2002.

(51) Int. Cl. G06F 17/21

(52) U.S. Cl. 715/205; 715/256; 715/808

(57) ABSTRACT

A method for providing scripts to customer representatives includes the steps of: receiving from a client computer information identifying a customer, a product, and a workflow; determining a script based on the received product and workflow information; obtaining the determined script, the script comprising text and variables, from a database; replacing the variables in the determined script with text in accordance with at least the received customer identification information to provide a customized script; and providing the customized script to the client computer for display.

### CROSS-REFERENCE TO RELATED APPLICATIONS

This application is a divisional application of U.S. patent application Ser. No. 10/226,681 filed Aug. 22, 2002, which claims priority to U.S. Provisional Patent Application No. 60/353,813 filed Feb. 1, 2002, the entirety of each of which is hereby incorporated by reference herein.

### FIELD OF THE INVENTION

This invention is in the field of computer programs and systems and business methods, particularly in connection with furnishing information to customer representatives, such as telephone sales representatives.

### BACKGROUND OF THE INVENTION

In an enterprise geared to sales of products and services to individual consumers, customer relations are in many cases most expeditiously carried out by telephone. In particular, financial services enterprises that provide financial products, such as credit cards, loans, accounts, and related products to consumers, make extensive use of telephone representatives. Telephone representatives of the financial services enterprise are a significant contact between many customers and the enterprise. Providing such representatives with effective current information is important in effecting the customer relations goals of the enterprise. Customers may initiate calls relating to an existing product or account, such as to obtain information about features or the current status of an existing product, such as a credit card account. Such calls represent an excellent opportunity to offer additional products and services to the customer. Such products and services may be in the nature of additional financial products, or may be non-financial products and services. In other instances, customers initiate calls to seek information regarding or to purchase specific products or services. In these telephone conversations, it is desirable that telephone representatives be able to obtain accurate information about the products and services.

Not all customers are eligible or qualified to obtain certain products or services. For example, a customer with overdue outstanding balances on credit card accounts would not be qualified to obtain additional products involving the extension of credit. However, information about credit history of individual customers is not ordinarily contained in a telephone service center. The credit and account history of individual customers of a financial enterprise is ordinarily contained in databases stored on mainframe computers. The use of mainframe computers results from both the very large volumes of data necessary to be stored, and the age of the databases. The databases were often created in the early 1990's or earlier, when there was no possibility of using PC based systems for storage of such large volumes of information. The data is accordingly typically stored in locations other than those of the telephone service centers, and is in a format which is not readily transferable to servers based on Intel microprocessors. Indeed, while the information in such databases may in many cases now be transferred for use on microprocessor based servers, the process of the transfer is time consuming, expensive, and risks loss or corruption of data. The transfer of such data is thus not desirable.

As a result of the foregoing factors, the telephone sales representative in a call center may engage in practices which may fail to use valuable telephone contact time or even risk alienating customers. For example, a customer may be offered a product for which the customer will not qualify. The customer will later be notified that he or she is not qualified, resulting in the expense of an additional contact, and alienating the customer. The representative may fail to offer a suitable product or service. For example, the telephone sales representative may be unaware that the caller is one of only relatively few customers eligible for a certain product.

It is important that telephone representatives have access to accurate scripts. By following such scripts, telephone sales representatives will meet legal and regulatory requirements for disclosures of information, be able to provide sales most effectively, and will provide accurate information to customers. Particularly if a variety of products are available, there may a significant volume of scripts available. Use of paper scripts is necessarily cumbersome. Storage of scripts on a local computer is preferred to paper scripts. However, significant memory resources and processing power are needed when the volume of scripts is high. Changes in scripts, such as to accommodate new products and offers, is cumbersome when either paper scripts or electronic files must be updated for each customer representative.

### SUMMARY OF THE INVENTION

In one aspect of the invention, there is provided a method, implemented at a server, for permitting telephone sales representatives at a client computer, access to information on qualification of customers to obtain particular financial products. In this method, the server receives from a client computer information relating to the type of financial product type, qualification type, and customer identification. Based on the received financial product type and qualification type, the server obtains qualification rules. Based on the received customer identification information, the server obtains customer credit information from a remote customer database. The server traverses the obtained customer credit information through the obtained qualification rules, and obtains a qualification result based on the step of traversing. The server instructs the client computer to display the obtained qualification result. The qualification rules are organized by category of the transaction. The customer information, including credit history, account status, preexisting products, and other information, is obtained from a remote customer database. The qualification result indicates whether the customer is qualified, pending qualification, or not qualified. If a not qualified result is identified at any point, then a not qualified result is returned to the client. If a pending qualification result is identified at any point, then the returned result is pending qualification. The process is carried out at the server location, thereby obviating a need to distribute the database information.

In another aspect of the invention, a system for providing customer qualification information for display to a computer operator is provided. The system includes computer hardware and software which, when running on a server, which have the functions of, based on information relating to financial product type and qualification type received from a client computer, obtaining qualification rules; computer hardware and software for, based on customer identification information received from a client computer, obtaining customer credit information from a remote customer database; computer hardware and software for traversing the obtained customer credit information through the obtained qualification rules to obtain a qualification result; and computer hardware and software for instructing the client computer to display the obtained qualification result.

In another aspect of the invention, a storage medium, having stored therein instructions, wherein the instructions, when executed by a processor, cause the processor to perform the steps of receiving from a client computer operated by a representative information relating to financial product type, qualification type, and customer identification; based on the received financial product type and qualification type, obtaining qualification rules; based on the received customer identification information, obtaining customer credit information from a remote customer database; at a server, traversing the obtained customer credit information through the obtained qualification rules to obtain a qualification result; and instructing the client computer to display the obtained qualification result.

In another aspect of the invention, there is a provided a method for providing scripts to representatives of an enterprise, including the steps of receiving from a client computer information identifying a customer, a product, and a workflow; determining a script based on the received product and workflow information, and obtaining the determined script, which includes text and variables, from a database. The variables are then replaced in the determined script with text in accordance with at least the received customer identification information to provide a customized script; and the customized script is provided to the client computer for display. Representatives first identify a customer upon the initiation of an interaction. The representatives identify a product for which a script is desired. Each product is associated with a number of scripts, which are classified into functional types. The proper script is identified based on the process flow stage. The functional types of script include sales script, containing all of the information needed for sales, a confirm sale script to confirm the customer's choice, benefit scripts to identify benefits, cancel scripts for use when a customer is canceling a product, emergency line increase scripts when a customer requests emergency credit line increase, an FAQ script to answer anticipated questions, a product information scripts, and rebuttal scripts for responses to customer's objections. The telephone representative employs a client computer, and scripts with variables, and related software, are stored and executed at a server location. In response to a client request, scripts are dynamically filled at the server with customer-specific information, such as name, price and product. The dynamically generated script is provided for display on the telephone representative's browser. A dynamically-generated general sales script is provided in the browser window. Links for items that are required in response to customer inquiries are also provided in the window. When a link is selected, a dynamically-generated script is provided specific to the type of customer inquiry.

In another aspect of the invention, a system for providing scripts to customer representatives includes computer hardware and software for determining a script based on the product and workflow information received from a client computer, computer hardware and software for obtaining the determined script, which includes text and variables, from a database; computer hardware and software for replacing the variables in the determined script with text in accordance with at least customer identification information received from the client computer to provide a customized script; computer hardware and software for providing the customized script to the client computer for display.

In another aspect of the invention, a storage medium has stored therein instructions, wherein the instructions, when executed by a processor, cause the processor to perform the steps of receiving from a client computer information identifying a customer, a product, and a workflow, determining a script based on the received product and workflow information, obtaining the determined script, said script comprising text and variables, from a database; replacing the variables in the determined script with text in accordance with at least the received customer identification information to provide a customized script; and providing the customized script to the client computer for display.

Advantages of the invention will be evident from the detailed description that follows.

### BRIEF DESCRIPTION OF THE FIGURES

FIG. 1 is an example of the environment in which the invention is employed.

FIG. 2 is a high-level process flow diagram in accordance with the invention.

FIGS. 2A, 2B and 2C are a process flow diagram illustrating a method of the invention.

FIGS. 3A and 3B are process flow diagrams illustrating a method of the invention.

FIG. 4 is a process flow diagram illustrating a method of the invention.

FIG. 5 is a process flow diagram illustrating a method of the invention.

### DETAILED DESCRIPTION

The method and system for providing information on qualification of customers will now be explained. Qualification means that the enterprise would be willing, for a particular product or service, subject to rules and restrictions determined by the enterprise, to offer the product or service to a customer. For example, if the product is a credit card account, the enterprise may be willing to offer the account up to a specific credit limit, with or without grace periods, with or without making cash advances available, and subject to specific rates of interest or formulas for determining rates of interest, which may vary depending on the transaction by which the account balance is generated. Different products and services may include products and services in the same general category, such as different credit card account products. The products may include automobile assistance programs, guarantees of payment of credit card balance in the event of death or disability, or any other product or service. The customer is typically an individual consumer. However, the invention may be applied to business and non-profit organizations. The method, system and computer program of the invention are described for use in a real-time interaction between a representative of the enterprise and the consumer. The representative is typically a telephone sales and service representative located at a call center. However, the interaction may also be a physical meeting between a representative and the customer. The interaction could also take place in another environment, such as a chat room, by an instant messaging protocol over a network, or similar system for exchanging information in text form. These are examples of real-time interactions, which require rapid provisioning of information to the representative. It will be understood that such interactions as chat rooms and instant messaging protocols, although possibly delayed more than a typical telephone interaction, are considered to be in real-time. The method, system and computer program of the invention may also be used in processing information in a non-real time interaction, such as postal mail, delivery services, fax, or conventional e-mail. The method permits a representative of an enterprise, such as a telephone representative, as a user of a client device, to initiate a request for qualification of a particular customer for a particular product. The method may commence with the commencement of an interaction between a representative and a customer. The interaction may be a real-time interaction. The customer may already be a customer of the financial institution. For example, the customer may have a credit card account with the financial institution. The telephone representative is using a client device, such as a microprocessor based personal computer system running a web browser, and a web server is provided by a server computer. The telephone representative provides information identifying the customer, such as a credit card number, and information identifying the product in question, as well as the qualification type or category of business interaction.

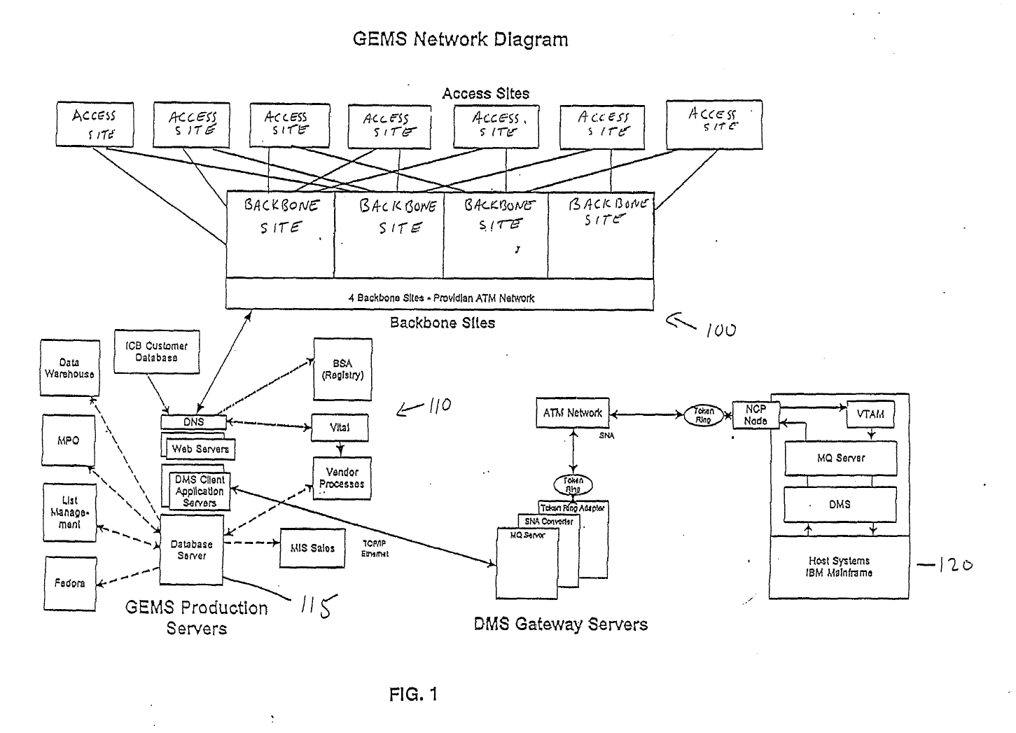

Referring to FIG. 1, an environment in which the system may be used will be discussed. A number of call center locations 100 are illustrated. These communicate with a web server 110, which features a local database 115. A remote database 120 is hosted on a mainframe. Data is exchanged from client computers at call center locations 100 to server 110. Server 110 can also request data from remote database 120.

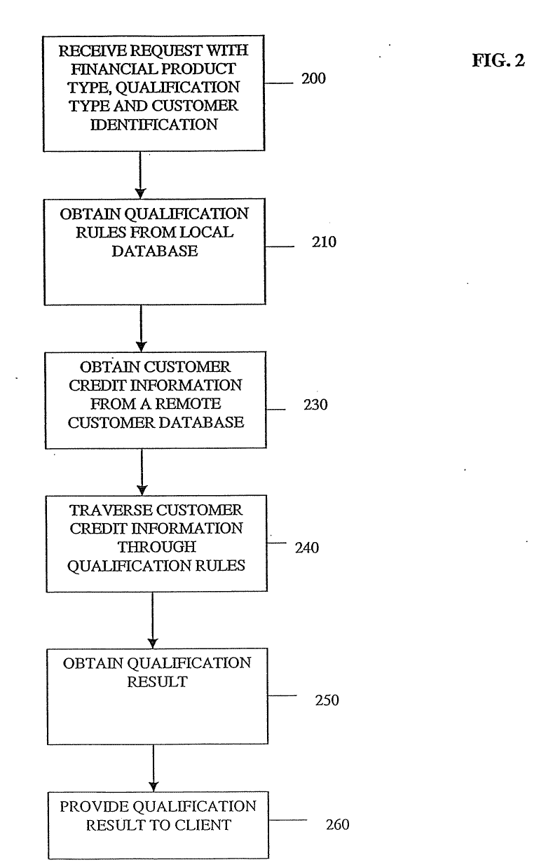

Referring now to FIG. 2, the process flow from the server side will be described in general terms. The process flow commences with the receipt of a request from the client. The request contains financial product type information, qualification type information and customer identity information, as indicated by block 200. The server then obtains qualification rules based on the financial product type information and the qualification type information, as indicated by block 210. Qualification rules map particular content of fields relating to credit history to at least two states, which may be “not qualified” and “qualified.” The process flow then proceeds to obtaining customer credit history information, as indicated by block 220. This information is resident in a remote database. This remote database is on a different computer system, such as a mainframe system, and is ordinarily at a different physical location from the server. The information in the remote database includes information regarding past payment, other accounts, related accounts (transferred or current) and current balance information. The process flow now proceeds to traversing the obtained customer credit information through the obtained qualification rules, as indicated by block 240. The process flow proceeds to obtaining a qualification result from the step of traversing, as indicated by block 250. The qualification result may be not qualified, qualified, or pending qualification for cases where more information is needed. The process flow then provides the qualification result to the client. The client displays the qualification result to the representative, who informs the customer. In embodiments involving a real-time interaction, the customer is informed during the interaction.

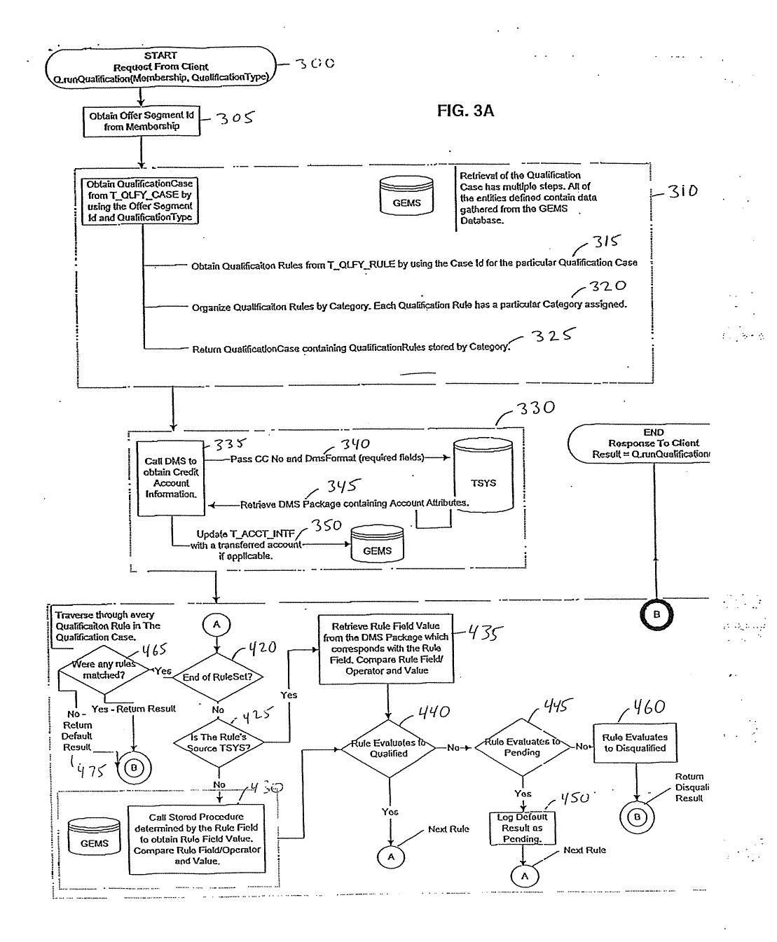

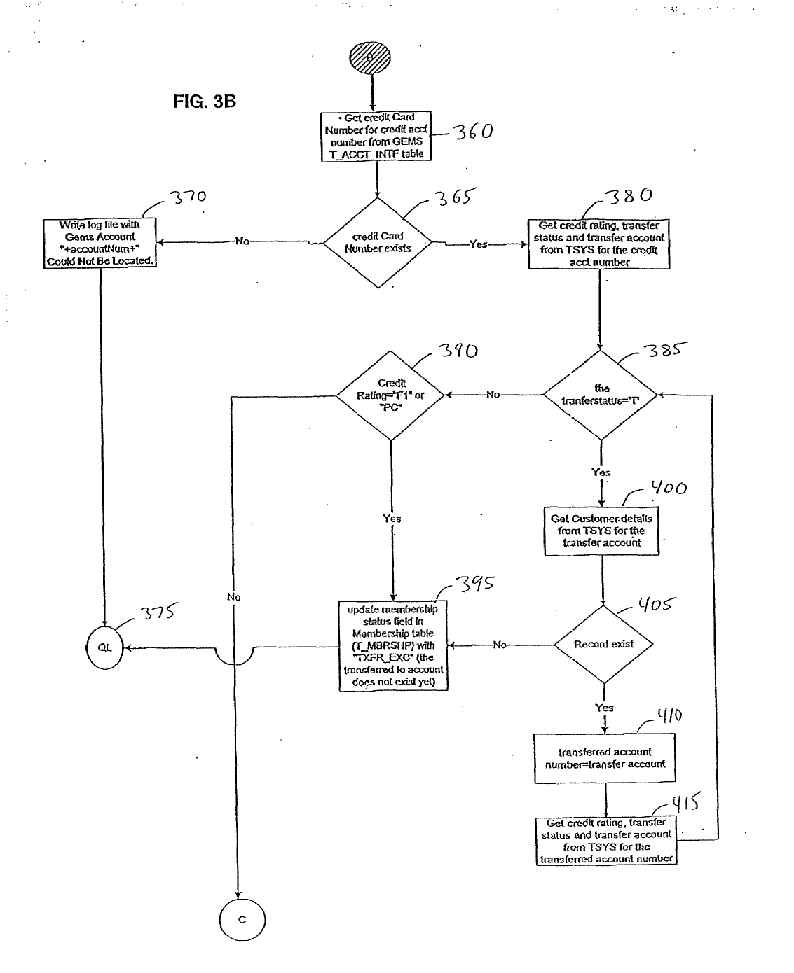

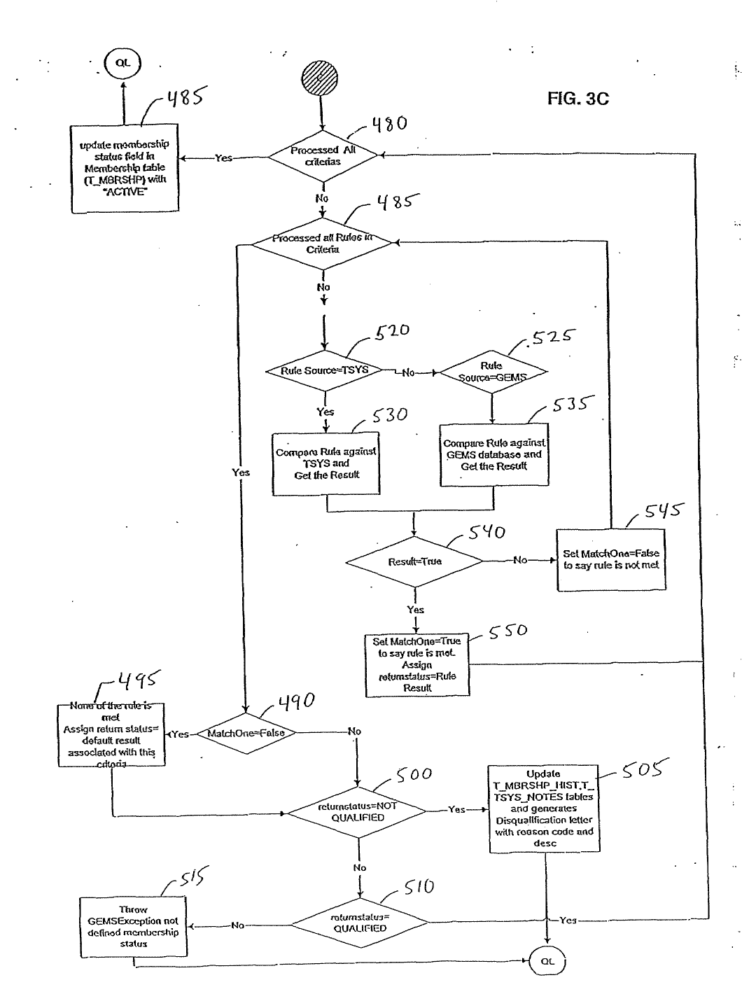

Referring now to FIG. 3, there is shown a detailed process flow of an embodiment of the invention. The request may include two items of data: qualification type and a membership instance. The qualification types are a number of categories defined by the business nature of the request. The business nature of the request may include: seeking to prequalify a customer in order to select a product suitable for the customer, seeking to qualify the customer for a product requested by the customer, seeking to determine if the customer is qualified for a renewal, batch processing of sales received through non-real time channels, and attempting to qualify a customer for a product after an earlier request has been placed in a pending status. The qualification types may accordingly be, for example, RealTimeSell, which is selected during front end sales when the goal is to prequalify a customer for a product and suggest a product suitable for the customer; RealTimePurchase, when the customer has requested a specific product; Renewal, when a membership in a product has neared its expiration date and qualification is required for a renewal period; BackendPurchase, which is specific to batch processing of sales, such as sales by mail channels, that may be processed in batch processing, and ReQualification, which refers to a membership that has been placed in a pending qualification status and is then attempted to be requalified. Fewer qualification types may be available, and further qualification types may be added by those of skill in the art.

The process flow commences with receiving a request from the client, containing membership data and qualification type data, as shown by block 300. The membership instance provided by the client in one embodiment contains information identifying the product and the customer. In particular, the membership instance may include an offer segment I.D. that identifies the product and a segment of the enterprise to which the product relates, a credit account number, and a customer identification number. The process flow proceeds to obtaining the offer segment I.D. from the membership data, as indicated by block 305. The process flow then proceeds to the steps of obtaining the qualification rules, which will be embodied in a QualificationCase, as indicated by block 310. There are a number of components to the process of obtaining the rules. The Qualification Rules are obtained from the local database or GEMS Database by using a case I.D. associated with the offersegment I.D. and the QualificationType, as indicated by block 315. In the database, each qualification rule has an assigned category. The process flow proceeds to grouping the Qualification Rules obtained in the previous step by category, as shown at 320. A Qualification Case is then returned containing Qualification Rules stored by Category, as shown at 325.

In one embodiment, the Qualification Cases have the attributes Case Id, which relates rules to a Qualification Case as noted above, CriteriaSet, which are objects that contain the Qualification Rules, Offer Segment Id, which is used to identify the segment to which the QualificationCase relates, and QualificationType, which is explained above. The Criteria Objects have the attributes Category Id, which identifies a category, and Default Result, which is used in the event a match cannot be made.

In greater detail, QualificationRules contain a type of rule, a field identifying the information to be evaluated, a rule operator, a result, and a result description. The categories may be, for example, current cycle information for the customer, the bank, the agent bank, a credit rating, whether a credit account is past due, whether a credit account is over the limit, whether there is a history owning PHA or DU properties, an offered and canceled indication, a similar products owned indication, and a similar products declined indication. These particular categories may be changed with business needs. It will be understood that for the category, the evaluation formula will test the rule field against a rule value using a rule operator, and obtaining a result, or mapping a value of a rule type to a qualification result.

Once the rules for qualification have been obtained, then the method proceeds to obtaining relevant information relating to the customer, as indicated by block 330. This information is referred to as credit account information. As noted above, this information resides at a database, as indicated at block 335. This is preferably a local database. Once the credit card information is obtained, identifying information, such as the credit card number and a distributed message service format are passed to the remote database. The credit account attribute names, which are equivalent to the rules fields in the qualification rules, are grouped in DMS format and submitted to a DMS module, which retrieves the credit account attributes values in the form of a DMS package, as indicated by block 345. The currency of the received credit account information should be checked. For example, the method may check for a transfer flag. If there is a transfer flag, then a new account number, also provided, must be checked. This process of checking for transfer flags and checking new account numbers may be repeated until a transfer flag is found that indicates that the credit account is not transferred. Local database information is then updated with the current credit account number, as indicated by block 350.

More specifically, referring to FIG. 3B, a credit card number is first obtained from the local database, as indicated by block 360. The process flow determines if the credit card number exists in the local database, as indicated by decision block 365. If the credit card number does not exist, the log file is appropriately noted, as indicated by block 370 and a detailed error message is returned to the client, as indicated at 375. The error messages are saved to error logs. The error logs may be researched manually, and errors may then be corrected as necessary by human operators. Customer contact and notification is conducted manually as part of the correction. If the credit card number exists, then the appropriate customer credit information is obtained from the remote database, designated TSYS, as indicated by block 380. The information of interest may include credit rating, transfer status, and transfer account number. If the account has not been transferred, as indicated by a NO reply to decision block 385, then the credit rating is checked, as indicated by decision block 390. If the credit rating is acceptable, as indicated by a NO reply to decision block 390 then the process flow moves to FIG. 3C. If the credit rating indicates that transferred to account does not exist, as indicated by a YES reply to decision block 390 then the membership table in the local database is updated to indicate that the transferred to account does not yet exist, as indicated by block 395, and a non-qualified result is returned to the client. Referring to a YES reply to decision block 385, if the transfer status indicates a transfer, then the customer credit information is again sought from the remote database, but now from the transfer account, as indicated by block 400. If the record does not exist, as indicated by a NO response to decision block 405, then the local database is updated as above. If the transferred account is identified, as indicated by a YES response to decision block 405, the transferred account number is equated to the transfer account, as indicated by block 410. The customer credit information is obtained from the remote database for the, transferred account, as indicated by block 415, and the process flow again inquires as to the status of the transfer flag.

An exemplary detailed process flow for the step of traversing the customer credit information through the qualification rules will now be explained. When the customer credit information pertaining to the customer has been obtained, then the information is compared to the qualification rules. For example, each Criteria Object in turn may be traversed, and all of the qualification rules in each Criteria Object traversed. In general, in a first check, if the rule evaluates to qualified, then the next rule is evaluated. If the rule evaluates to pending qualification, then the default result of pending qualification is logged, and the process flow proceeds to the next rule. If the rule evaluates to disqualified, then a disqualified result is returned to the client. The telephone representative can promptly learn if the customer is not qualified, and either not make the offer, or indicate that the offer cannot be made.

If no matches are found in a particular criteria object, then the default result is returned, as provided in the criteria object. The absence of matches means an absence of information in the database regarding the customer. If the process flow has reached this point, there has been no result of not qualified. If there are matches, but no qualified result, then the default must be checked to determine if a pending qualification result would be changed to qualified.

In the embodiment using a local database and a remote database, the source of each rule is determined. Referring again to FIG. 3A, the process flow proceeds to determine whether the end of the rule set has been reached, as indicated by decision block 420. If not, then the it is determined whether the source of the rule is the remote database, as indicated by decision block 425. If the source is the local database, the rule field is retrieved, and then an associated stored procedure is called, which retrieves a particular rule field value, as indicated by block 430. For example, if the field relates to whether a similar product is already owned by the customer, a particular stored procedure is called. The offer segment I.D. and party I.D. are taken from the Membership information for the request and then a check is made against all other credit accounts related to that party I.D. as to whether there is a similar product already owned. The result of pending qualification is returned if a similar product is already owned.

In this embodiment, if the source is the remote database, the process flow moves to block 435. The rules field value is also retrieved, but the value is obtained from the DMS package returned from the remote database. This is then used to evaluate the rule. Regardless of the source of the rule, if the rule evaluates to qualified, then the process flow proceeds to the next rule, as indicated by decision block 440. If the rule does not evaluate to qualified, in this example, rules may evaluate to pending. If the rule evaluates to pending, as indicated by block 445, then the default is updated to pending, as indicated by block 450. The default is otherwise qualified. If the rule evaluates to disqualified, as indicated by block 460 then a disqualified result is provided to the client for display to the representative.

If the end of the rule set was reached, then it is evaluated whether any rules were matched, as indicated at 465. If any rules were matched, then the result from that rule is returned, as indicated at 470, and the result is displayed for the representative. The result may in principle be either qualified or not qualified. If no rules are matched, then the default result is provided to the client, as indicated at 475.

Referring to FIG. 3C, an exemplary process is further illustrated for customers that pass the tests of FIG. 3B. If all criteria have been processed, as indicated by decision block 480 then the membership status field in the membership table is updated, as indicated by block 485, and the qualification result provided to the client. If not all criteria have been processed, then the process flow proceeds to a determination whether all rules in the current criteria have been processed, as indicated by decision block 485. If all rules have been processed, it is determined if there are any matches, as indicated by decision block 490. If there are no matches, then a default qualification result is returned, as indicated by block 495. If a rule has been met, then the return status for the rule is returned. The matched result or default is checked to determine if it is not qualified, as indicated by decision block 500. If the result is not qualified, then a table is updated and a disqualification letter is generated, as indicated by block 505. The not qualified status is also communicated to the client for display. If the status associated with the rule or default is qualified, as indicated by decision block 510, then the process flow returns to determine if all criteria have been processed. If the status associated with the rule or default is a status other than qualified, then this is an exception, as indicated by block 515, and the client is provided instructions to display the exception status. If not all rules have been processed, then the source of the rules is determined. The remote database is checked and the local database are checked, as indicated by decision blocks 520, 525. The rule is compared against the respective database, as shown by blocks 530, 535. It is determined whether the rule is met, as indicated by decision block 540. If the rule is not met, a value, which may be referred to as MatchOne, is set to indicate the rule is not met, as indicated by block 545, and the process flow returns to determine whether all rules have been processed. If the rule is met, the value is set to indicate the rule is met, as indicated by block 550, and the process flow returns to determine if all criteria have been processed.

Various advantages of the foregoing process will be appreciated. The response is received in real time during an interaction, so that there is little delay, and the customer may be offered proper products. The processing takes place at the server, so that workstations may be equipped with relatively light processing power, and will not need specialized software. Rules are located at the server, so that rules may be readily updated. The customer credit information remains on the remote server, avoiding the expense of installing extensive new storage capacity and conducting data conversions.

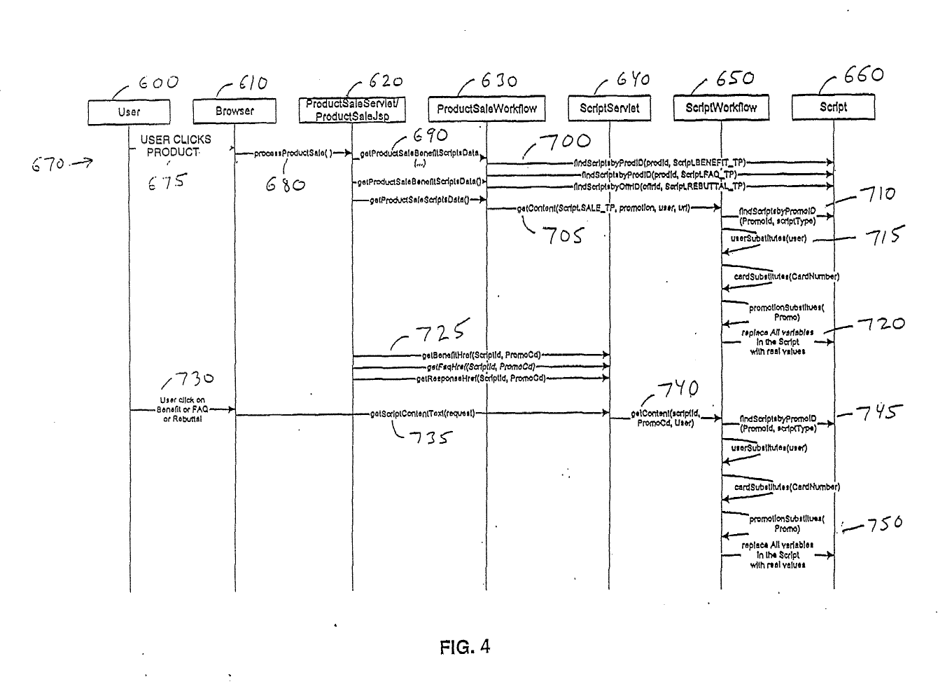

A method of providing dynamic scripts to the telephone representatives will now be explained. Referring to FIG. 4, the process flow of the method will be explained. The blocks at the top of the page indicate the user 600, various software components, and the script files. Browser 610 is running on the user's client computer, usually a microprocessor-based personal computer. The software components ProductSaleServlet/ProductSaleJsp 620, ProductSaleWorkflow 630, ScriptServlet 640, and ScriptWorkflow 650 run on a server. Script 660 is stored in a database. At the commencement of the telephone call or other interaction, a first screen workflow, also called a member profile workflow, module presents the customer representative with the option to sell a qualified product or service a customer for the products owned. A first portion of the process flow, indicated generally at 670, commences with a user selecting a product from the first screen workflow. Information identifying the page of the script that is open in the user's browser window is passed back to the server. Depending upon the state of the customer in a particular workflow, appropriate scripts are automatically loaded dynamically for that workflow page. The state of the customer means for example, whether the customer is being sold a product new to the customer, or whether the customer is seeking service for an existing product. The workflow modules that may be selected include a product sale workflow, for instances in which the representative is attempting to sell a product to the customer, a service workflow, for instances in which the customer requires service relating to a previously-purchased product, and an emergency credit line increase workflow, for instances in which the customer is requesting an emergency credit line increase. Other workflow modules may be selected depending upon the needs of a particular enterprise.

In the example of a product sale workflow, as shown in FIG. 4, after receiving the user's selection of a product sale, as indicated at 680, the browser 610 transmits a request with the information, including customer and product information, to a product sale servlet or JavaScript 620 running on a server. This product sale servlet or JavaScript 620 requests a product sales script and product sales benefit scripts from the Product Sale Workflow, as indicated at 690. The Product Sale Workflow module generates requests for appropriate scripts, which in this example are the benefit script for the requested product, the FAQ script for the product, and the rebuttal script for the offer, as indicated at 700. The request is sent to a script database. These scripts are obtained from the database. The scripts may be available in HTML format, with variables indicated. The Product Sale Workflow module also sends content, such as the promotion name and the customer name, and the user name, as indicated at 705, to the Script Workflow. The Script Workflow module sends a request for the scripts identified by a unique promotion identification to the script database, as indicated at 710. The Script Workflow module retrieves the scripts with text and variables, then assigns values to the variables, indicated generally at 715, replaces all variables in the script, indicated at 720, and provides the resulting script, preferably in HTML, to the browser of the user. The telephone representative, or user, may then read the script, with key variables, such as the customer's name, inserted. The script also includes links for additional items of information, such as benefits of a product, frequently asked questions about a product, or rebuttals to customer responses. The script text with variables, which may be extensive, may be stored on a server. The dynamic generation of the scripts from the script text and the particular information for the customer or account may also occur at a server. The telephone representative's computer need only run a browser to provide scripts in accordance with the invention.

In the illustrated embodiment, the ProductSaleServlet or equivalent software, in response to the request 680 from the browser, requests benefit, FAQ and rebuttal scripts identified by promotion code. These requests are then held until the user requests them.

In another path of the process flow of FIG. 4 the user, during the conversation, generally in response to a customer comment, decides that an explanation of a product benefit, and answer to a question about a product, or a rebuttal to an objection, is needed. The user clicks on Benefit or FAQ or Rebuttal, as indicated at 730. The browser directly requests script content from the script servlet, as indicated at 735. As noted above, the script servlet is running on the server. The script servlet then requests the content, with variables inserted, from the script workflow module, as indicated at 740. The script workflow module requests the scripts, as indicated at 745, and replaces the variables and generates the scripts, as indicated at 750. These dynamically-generated scripts are then provided to the user's browser. These scripts are typically displayed in a pop-up window, so that the user may readily return to the script.

The script types are generally as follows. The sales script is a full sales presentation, including identification of the caller, confirming the identify of the customer, and a complete explanation of the product. The confirm sales script reviews certain information about cost, billing and benefits, and provides the option of accepting or declining. The script may dynamically indicate any gifts. Benefit scripts contain particular product benefits, such as, for an auto club product, credit for collision repairs, a service hotline, maintenance discounts, and travel benefits. Links may be provided on screen for each of several, such as five to ten, benefits for each product. This enables the representative to click on any selected link and read a dynamic script describing a particular benefit. Cancel scripts are selected during the cancellation process, when a customer requests cancellation. Emergency line increase scripts are selected in response to a request for an emergency line increase. Preferably, the method and system of the invention simultaneously determines if the customer is qualified for the emergency line increase, using the procedure above, and provides a script identifying the particular reason for a not qualified result. Such a reason may be not being current on another account, for example. FAQ scripts are preferably selected by links corresponding to customer questions. For example, a link may be provided for the questions “Can I cancel at any time?” and “Do I have to have my membership renewed automatically?” The user clicks on this link, and the appropriate script, which has already been generated, is displayed in a window. The product information script contains general information about the product, and may be selected for the product as a whole. Rebuttal scripts are provided in the form of possible customer answers. For example, for an auto plan, possible customer answers may include “I have another auto plan,” or “I am a mechanic.” By selecting the proper customer answer, the dynamically generated appropriate rebuttal is provided.

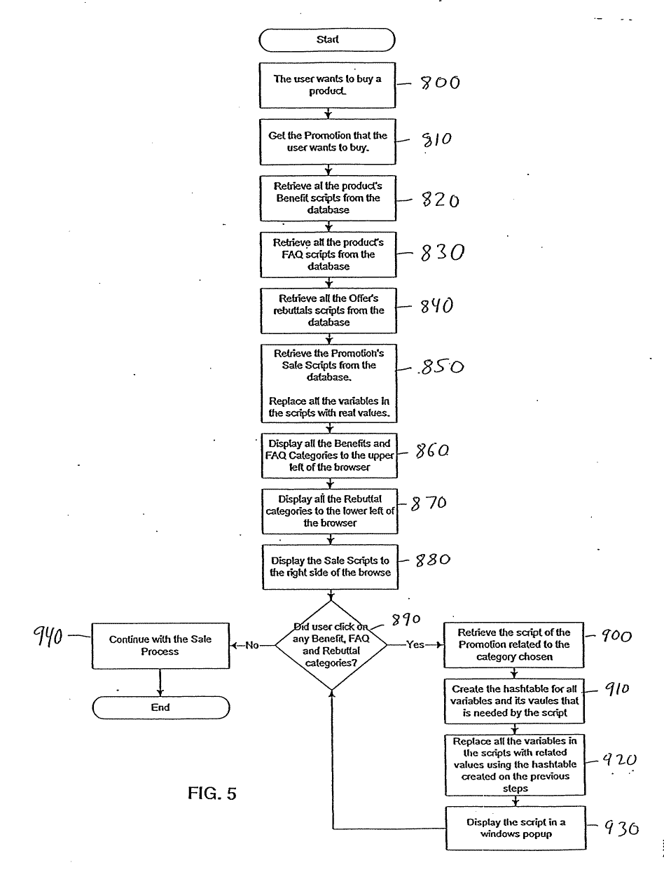

The process flow will now be explained with reference to FIG. 5. The process starts when the customer indicates a desire to buy a product. The user clicks to indicate that a product is desired, as indicated at block 800. The promotion indicated by the selection is retrieved from a database, as indicated by block 810. All of the product's benefit scripts are retrieved, as indicated in block 820. All of the FAQ scripts associated with the product are also retrieved, as indicated by block 830. All of the rebuttals associated with the offer are retrieved, as indicated by block 840. The sales scripts are retrieved, and all variables are replaced with real values at the server, as indicated by block 850. The benefits, FAQ categories, and rebuttal categories are displayed as links visible on the page in the browser. For example, benefits and FAQ categories may be displayed to the upper left of the browser window, as indicated by block 860, and the rebuttal categories at the lower left side of the browser. The dynamically-generated sales script itself is provided to the browser and is immediately displayed, such as on the right side of the browser, as indicated by block 880, to be read by the telephone representative.

If a selection of any benefit, FAQ or rebuttal link is detected, as indicated by decision block 890, then the script of the promotion corresponding to the category of the selected link is retrieved, as indicated by block 900. An appropriate mapping table, such as a hashtable, is created for all variables and values needed by the script, as indicated by block 910. The variables in the scripts are replaced with the corresponding values from the table, as indicated by block 920. The script, having been dynamically generated, is then displayed in a popup window in the browser, as indicated by block 930. If no selection of a link is made, the system continues with the sale process, as indicated by block 940.

It will be understood that the foregoing method is accomplished in computer programs which are stored on a storage medium, and contain instructions which, when executed on a computer, cause the computer to carry out the steps of the method. The invention may also be characterized as a computer system having means for carrying out each of the foregoing steps.

The invention may run on Unix servers running Solaris operating systems, with NT client or similar workstations with Netscape browsers for client requests. The application server and web server could be deployed in a purely NT environment. HTTP may be used for page delivery, with TCP/IP used for all transmissions, and FTP for file delivery and staging. Other protocols may be employed as well. The source code is preferably developed in Java, although C++ may be used. An exemplary hardware configuration is shown in FIG. 3.

Additional functionality may be included in the system of the invention in a client server environment. Such functionality may include updating addresses and responding to fulfillment requests such as requests for replacement cards. Batch processing may be included for such purposes as billing, and updating memberships requested by external sources, such as vendors and external telemarketers, and other functionality.

While the invention has been described with respect to particular embodiments, those of ordinary skill in the art will appreciate variations in the method, software, and components that are within the scope and spirit of the invention.

1. A method for providing scripts to customer representatives, comprising the steps of:
receiving, from a client computer, information identifying a customer, a financial product, and a workflow;
determining a script based on the received product and workflow information;
obtaining the determined script, said script comprising text and variables, from a database;
replacing the variables in the determined script with text in accordance with at least the received customer identification information to provide a customized script;
providing the customized script to the client computer for display;
determining a qualification type and a membership instance associated with the customer, wherein the qualification type is based on categories defined by a nature of a request for the financial product and the membership instance identifies the financial product and the customer;
determining qualification rules based upon the financial product and the qualification type;
receiving credit history information associated with the customer from at least one remote database;
processing the credit history information through the qualification rules to obtain a qualification result; and
providing the qualification result to the client.

2. The method of claim 1, wherein workflow information is obtained by the client computer automatically communicating a script page being displayed on the client computer.

3. The method of claim 1, wherein the workflow information comprises whether the customer is being sold a financial product new to the customer.

4. The method of claim 1, wherein the workflow information comprises whether the customer is requesting service relating to an existing financial product.

5. The method of claim 1, wherein the customized script comprises one or more links that upon selection display a further customized script.

6. The method of claim 5, wherein the further customized script is displayed in a popup window.

7. A system for providing scripts to customer representatives, comprising:
means for determining a script based on financial product and workflow information received from a client computer;
means for obtaining the determined script, said script comprising text and variables, from a database;
means for replacing the variables in the determined script with text in accordance with at least customer identification information received from the client computer to provide a customized script;
means for providing the customized script to the client computer for display;
means for determining a qualification type and membership instance associated with the customer, wherein the qualification type is based on categories defined by a nature of a request for the financial product and the membership instance identifies the financial product and the customer;
means for determining qualification rules based upon the financial product and the qualification type;
means for receiving credit history information associated with the customer from at least one remote database;
means for processing the credit history information through the qualification rules to obtain a qualification result; and
means for providing the qualification result to the client.

8. The system of claim 7, wherein workflow information is obtained by the client computer automatically communicating a script page being displayed on the client computer.

9. The system of claim 7, wherein the workflow information comprises whether the customer is being sold a financial product new to the customer.

10. The system of claim 7, wherein the workflow information comprises whether the customer is requesting service relating to an existing financial product.

11. The system of claim 7, wherein the customized script comprises one or more links that upon selection display a further customized script.

12. The system of claim 11, wherein the further customized script is displayed in a popup window.

13. A storage medium, having stored therein a plurality of instructions, wherein the plurality of instructions, when executed by a processor, cause the processor to perform the steps of:
receiving from a client computer information identifying a customer, a financial product, and a workflow;
determining a script based on the received product and workflow information;
obtaining the determined script, said script comprising text and variables, from a database;
replacing the variables in the determined script with text in accordance with at least the received customer identification information to provide a customized script;
providing the customized script to the client computer for display;
determining a qualification type and membership instance associated with the customer, wherein the qualification type is based on categories defined by a nature of a request for the financial product and the membership instance identifies the financial product and the customer;
determining qualification rules based upon the financial product and the qualification type;
receiving credit history information associated with the customer from at least one remote database;
processing the credit history information through the qualification rules to obtain a qualification result; and
providing the qualification result to the client.

14. The storage medium of claim 13, wherein workflow information is obtained by the client computer automatically communicating a script page being displayed on the client computer.

15. The storage medium of claim 13, wherein the workflow information comprises whether the customer is being sold a financial product new to the customer.

16. The storage medium of claim 13, wherein the workflow information comprises whether the customer is requesting service relating to an existing financial product.

17. The storage medium of claim 13, wherein the customized script comprises one or more links that upon selection display a further customized script.

18. The storage medium of claim 17, wherein the further customized script is displayed in a popup window.
